(19) United States
(12) Patent Application Publication
(10) Pub. No.: US 2020/0001212 A1
(43) Pub. Date: Jan. 2, 2020

(54) FILTERING METHOD AND APPARATUS

(71) Applicant: Paul Neiser, Mountain View, CA (US)

(72) Inventor: Paul Neiser, Mountain View, CA (US)

(21) Appl. No.: 16/455,737

(22) Filed: Jun. 27, 2019

Related U.S. Application Data
(60) Provisional application No. 62/763,695, filed on Jun. 27, 2018.

(51) Int. Cl. B01D 33/073; B01D 35/06; B01D 53/32; B01D 53/22

(52) U.S. Cl. CPC B01D 33/073; B01D 35/06; B01D 2033/07; B01D 53/22; B01D 53/32

(57) ABSTRACT

A force generating apparatus is configured to induce a force on at least a portion of objects of interest within a first channel system between a first point and a second point, where the average force comprises a non-zero component directed from the first point towards the second point. The magnitude of the associated change in the thermodynamic properties of the objects of interest between two given points within the first channel system is a function of the relevant properties of the channel system, such as the shear stress coefficient or the resistivity of the channel system to bulk flow of objects of interest. A second channel system can comprise a first point and a second point, and the second point of the second channel system can be diffusively coupled to the second point in the first channel system. The relevant properties of the second channel system can be configured to be different to the relevant properties of the first channel system. The difference in the magnitude of the change of thermodynamic properties between the first and second points in the first channel system and the second channel system can be employed to increase the pressure of objects of interest in a second reservoir relative to a first reservoir. A pressure modification apparatus and method can be used to convert thermal energy into useful energy, such as mechanical work or electricity, for example.

### CLAIM OF PRIORITY

The present patent application is a non-provisional of, and claims the benefit of priority of U.S. Provisional Patent Application No. 62/763,695 filed on Jun. 27, 2018, which is hereby incorporated by reference herein in its entirety.

### FIELD

The invention relates to apparatuses and methods for filtering, pumping, and/or concentrating objects of interest.

### BACKGROUND

Filtering, pumping or changing the concentration of objects of interest typically consumes useful energy. For example, in a typical desalination plant employing reverse osmosis, the separation of the solute from the solution consumes useful power in the form of electricity. Similarly, the pumping of fluid by a conventional aircraft engine during the production of thrust consumes useful energy provided separately in the form of hydrocarbon fuel or in the form of an electrical battery, for example.

### SUMMARY

According to the present invention, methods of facilitating the diffusion of objects of interest from a first reservoir to a second reservoir, comprise providing a filtering apparatus, wherein the filtering apparatus comprises: a body force generating apparatus; a first channel system, wherein the first channel system comprises a first point and a second point, wherein objects of interest are able to move through the first channel system between the first point and second point, wherein the body force generating apparatus can be configured to apply a force on objects of interest within at least a portion of the first channel system, wherein the force comprises a non-zero component directed from the first point towards the second point on average; and a second channel system, wherein the second channel system comprises a first point and a second point, and wherein objects of interest are able to move through the second channel system between the first point and second point, wherein the body force generating apparatus can be configured to apply a force on objects of interest within at least a portion of the second channel system, wherein the force comprises a non-zero component directed from the first point towards the second point on average; and wherein the second point in the second channel system is diffusively coupled to the second point in the first channel system, and wherein the average shear stress coefficient of the second channel system between the first point and the second point is larger than the average shear stress coefficient of the first channel system between the first point and the second point. In a subset of embodiments, the first point in the second channel system is diffusively coupled to a second reservoir. In a subset of embodiments, the first point in the first channel system is diffusively coupled to a first reservoir.

As described herein, the geometry, shear stress coefficient, or resistivity to bulk flow of objects of interest, of a channel in a filtering apparatus can be configured to preferentially transmit objects of interest from the first reservoir to the second reservoir. The first total transmissivity of objects of interest through the filtering apparatus from the first reservoir to the second reservoir can thus be configured to be larger than the second total transmissivity of objects of interest through the filtering apparatus from the second reservoir to the first reservoir.

This property of a filtering apparatus can be employed to generate a difference in the concentration of objects of interest in a second reservoir relative to a first reservoir for a static boundary condition. This property can also be employed to generate a net diffusion of objects of interest, through a filtering apparatus for a dynamic boundary condition. The energy of the net diffusion, i.e. the energy associated with the resulting bulk flow of objects of interest, is provided by the thermal energy of the objects of interest in some embodiments of the invention. The bulk flow of OI can be employed in the production of thrust in an aircraft propulsion unit, for example. The bulk flow of OI can also be employed in the conversion of thermal energy of a fluid into useful work, such as mechanical work or electrical energy.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a cross-sectional view of one embodiment of the invention.

FIG. 2 shows a cross-sectional view of another embodiment of the invention.

### DETAILED DESCRIPTION OF THE DRAWINGS

The term “medium” used herein describes any material which is capable of containing, carrying, transporting, or transferring an object of interest. A medium can be a gas, liquid, solid, or vacuum, for example. By default, a medium refers to the collection of all objects which interact with a specified apparatus.

The term “object” used herein describes any component of a medium. An object can be described as a particle, such as a dust particle, a soot particle, a water droplet, or a water molecule. Other examples of objects are subatomic particles such as electrons or protons. An object can also be described as a wave, such as a photon, phonon, or an ocean wave. An object can also be a virtual object, such as a virtual photon, virtual electron or virtual positron, as described by quantum mechanics. An object can have a property of interest, as well as a defining property, which can be used to distinguish an object from other objects of the medium. The invention applies to any medium which can be considered to comprise distinct objects.

One can define a “dynamic boundary condition” as a simplified scenario in which the properties of the medium at a first reservoir and a second reservoir are identical and uniform in time and space. For example, the density of OI in the first reservoir and the second reservoir can be identical for the dynamic boundary condition, where the density is measured at a very large distance from an embodiment of the invention, such that the embodiment does not affect the measurement.

One can define a “static boundary condition” as a simplified scenario in which a first and second reservoir are finite in size and isolated from each other and any other reservoirs apart from an embodiment of the invention allowing the exchange of OI between the first and second reservoirs. In the static boundary condition, the macroscopic properties of interest of the medium in the first and second reservoirs have reached a steady state value, where the steady state value is substantially constant in time and space, i.e. substantially uniform throughout a reservoir. Such macroscopic properties can refer to the pressure, temperature, or density of a medium, for example. For example, the density of OI can be substantially uniform or constant throughout a first and second reservoir, which also applies to the portions of the reservoirs in proximity of an embodiments of the invention. The value of the average density in the first and second reservoir need not be identical for the static boundary condition.

In some embodiments of the invention, the defining property can be the location of the object of interest prior to interacting with an embodiment of the invention, or a filtering apparatus, where the location can be the position in a first reservoir or a second reservoir, where the first reservoir is located on one side of an embodiment, or a filtering surface or a filtering plate, and the second reservoir is located on the other side of an embodiment, or a filtering surface or a filtering plate. The “first transmissivity” can be the probability of an object of interest which enters or interacts with an embodiment or a filtering apparatus from a first reservoir to move or diffuse to a second reservoir through an embodiment or filtering apparatus. Similarly, the “second transmissivity” can be the probability of an object of interest which enters or interacts with an embodiment or filtering apparatus from a second reservoir to move or diffuse to a first reservoir through an embodiment or filtering apparatus. The “first entering probability” is the probability of an object of interest, which is located in a first reservoir and which interacts with an embodiment of the invention, or with a filtering apparatus, of entering said embodiment or apparatus from the first reservoir, as opposed to being reflected by an outside surface of an embodiment or filtering apparatus, or being reflected or scattered by another object prior to entering an embodiment or filtering apparatus in a manner which prevents the object of interest from entering the embodiment or filtering apparatus. Similarly, the “second entering probability” is the probability of an object of interest, which is located in a second reservoir and which interacts with an embodiment of the invention, or with a filtering apparatus, of entering said embodiment or apparatus from the second reservoir.

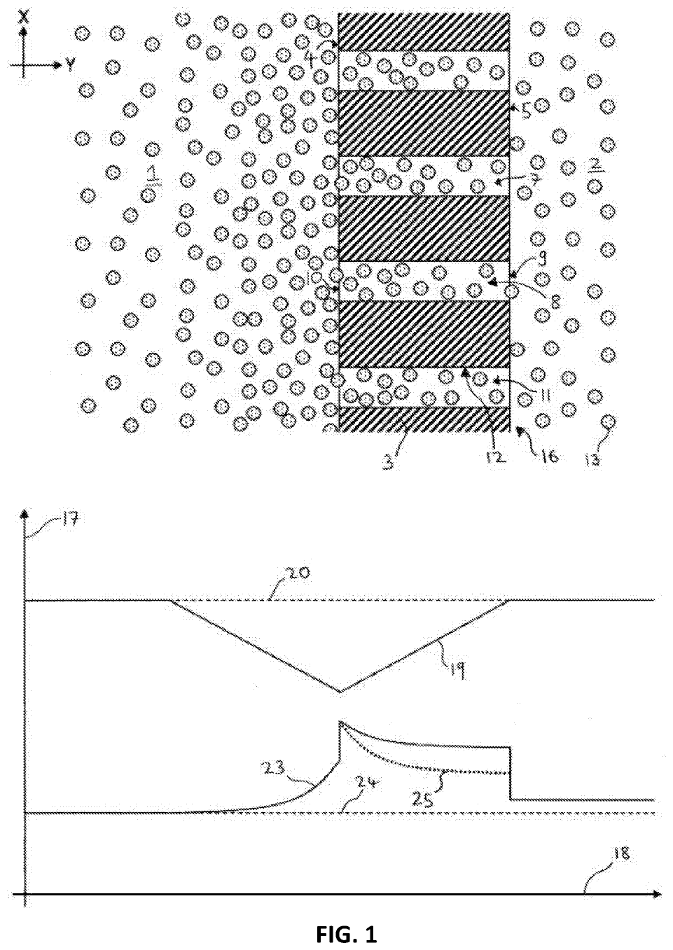

For example, for the embodiment shown in FIG. 1, the first entering probability can be the probability of an object of interest located in the first reservoir 1 from diffusing or moving into the potential well described by line 19, given that the object of interest is about to diffuse or move into the potential well, i.e. a region of reduced potential energy. Such an object of interest can be scattered by another object of interest which is leaving the potential well and about to enter the first reservoir 1, thus preventing the object of interest which is about to enter the potential well from actually entering the potential well, for example. Similarly, for the embodiment shown in FIG. 1, the second entering probability can be the probability of an object of interest located in the second reservoir 2 from diffusing or moving into the potential well described by line 19, given that the object of interest is about to diffuse or move into the potential well, i.e. a region of reduced potential energy. Since the region of reduced potential energy begins within a channel, such as channel 7 or channel 8, and at the opening of a channel, such as opening 9, from the perspective of an object of interest located in the second reservoir, the second entering probability is equal to the probability of an object of interest entering a channel through a channel opening, such as second opening 9, given that the object of interest is about to enter the potential well. Such an object of interest can be scattered by another object of interest which is leaving the potential well and about to enter the second reservoir 2, thus preventing the object of interest which is about to enter the potential well from actually entering the potential well, for example. In addition, an object of interest which is about to enter the potential well can be reflected by second surface 5, and thus be prevented from actually entering the potential well, for example.

In accordance with some embodiments of the invention, the product of the first entering probability and the first transmissivity is not equal to the product of the second entering probability and the second transmissivity for a static boundary condition. In accordance with some embodiments of the invention, the product of the first entering probability and the first transmissivity is greater than the product of the second entering probability and the second transmissivity for a static boundary condition. The product of the first entering probability and the first transmissivity is denoted the “first total transmissivity”, and the product of the second entering probability and the second transmissivity is denoted the “second total transmissivity”.

FIG. 1 shows a cross-sectional view of one embodiment of the invention.

In the first reservoir 1 and the second reservoir 2, the medium comprises objects of interest, or “OI”, which are schematically represented by individual particles, such as the schematic representation of particle 13. For simplicity, the medium can be considered to be an ideal gas comprising monatomic molecules. In other embodiments the medium can consist of other types of objects, such as water molecules or mobile electrons in a metal lattice. In any one reservoir or chamber, the medium can also comprise several different types of objects, such as sodium and chlorine ions found in salt water.

In FIG. 1, the invention is embodied by a filtering apparatus 16, which is placed within a potential gradient. This potential gradient can be provided externally in some embodiments. For example, the potential gradient can be gravitational in nature. The gravitational potential gradient can be provided by an external mass, such as a planet. In the absence of a sufficiently strong external potential gradient, embodiments of the invention are configured to produce an artificial potential field. Several methods are available for producing such a potential field and field gradient for any given type of OI, as will be discussed.

The filtering apparatus 16 has a first surface 4 and a second surface 5, both of which are planar, and parallel to the XZ-plane.

In this embodiment, bulk material 3 is perfectly reflective to OI. In other words, OI are not able to pass through, or diffuse into bulk material 3. In other embodiments, bulk material 3 can transmit or absorb a fraction of OI which come into contact with bulk material 3. Bulk material 3 can be made of any suitable material, such as metal, composite, or ceramic. In some embodiments, bulk material 3 can also be described as a fabric. Bulk material 3 can comprise graphene in some embodiments. Bulk material 3 can comprise carbon nanotubes. In the case in which the OI are electrons, bulk material 3 can be an electrical insulator such as glass, and a channel can be an electrical conductor such as copper. Bulk material 3 can be manufactured using methods known in the art of semiconductor manufacturing, for example.

In this embodiment, several identical channels, such as channel 7 or channel 8, allow OI from the first reservoir 1 to pass through bulk material 3 to the second reservoir 2, and vice versa. Each channel has a first opening, such as first opening 10, and a second opening, such as second opening 9. The cross-section of channel 8 is constant, and circular when viewed along the Y-direction. In other embodiments, a channel can have any cross-section, such as square, rectangular, or polygonal cross-sections. In the embodiment shown, the channels are arranged in a periodic pattern in the XZ-plane. For example, the centers of the channels in the XZ-plane can be located at the nodes of a square pattern. An individual channel, or a collection of channels, can also be referred to as a channel system.

In some embodiments, the width of a channel, such as channel 8, is slightly larger than the diameter of an OI. In some embodiments, the width of a channel, such as channel 8, is on the order of the collision diameter of an OI. In some embodiments, the width of a channel is less than five times the collision diameter of an OI. In some embodiments, the width of a channel is less than ten times the collision diameter of an OI. In some embodiments, the width of a channel is several orders of magnitude larger than a collision diameter of an OI. In some embodiments, the width of a channel is less than the mean free path of an OI in the first reservoir in proximity to first surface 4. In some embodiments, the width of a channel is less than ten times said mean free path. In some embodiments, the width of a channel is less than a distance several orders of magnitude larger than said mean free path. In some embodiments, the channel width is constant in time. In other embodiments, this need not be the case. For instance, the width of a channel can be regulated to control the rate of diffusion of OI through the filtering apparatus 16. The width of a channel can take any suitable value at any instant in time, where suitability depends on the objective and constraints of a particular application.

In accordance with some embodiments of the invention, such as the embodiment shown in FIG. 1, at least a portion of the reflections of an OI from an inside surface of a channel of a filtering apparatus, such as inside surface 12 of channel 11, cannot be described as specular reflection. Instead, such reflections can be considered to be diffuse reflections, i.e. the angle of reflection is not a deterministic function of the angle of incidence. For a given angle of incidence, there are a range of possible angles of reflection for an OI which is reflected by an inside surface of a channel. In other words, the inside surface of a channel can be considered to scatter OI. The scattering can be caused by small surface irregularities or surface roughness of the inside surface. The scattering can also be caused by the temporary adsorption of OI to the inside surface. Such adsorption can be caused by dipole-dipole interactions or Van der Waals forces, for example. Small irregularities in the spatial distribution of the magnitude or direction of such attractive forces can also contribute to the scattering effect associated with in diffuse reflections. In accordance with some embodiments of the invention, the wall friction coefficient associated with the bulk flow of OI through a filtering apparatus is non-zero. This is the default configuration for most channels. The wall friction can be considered to give rise to a resistivity associated with the flow of OI through the filtering apparatus.

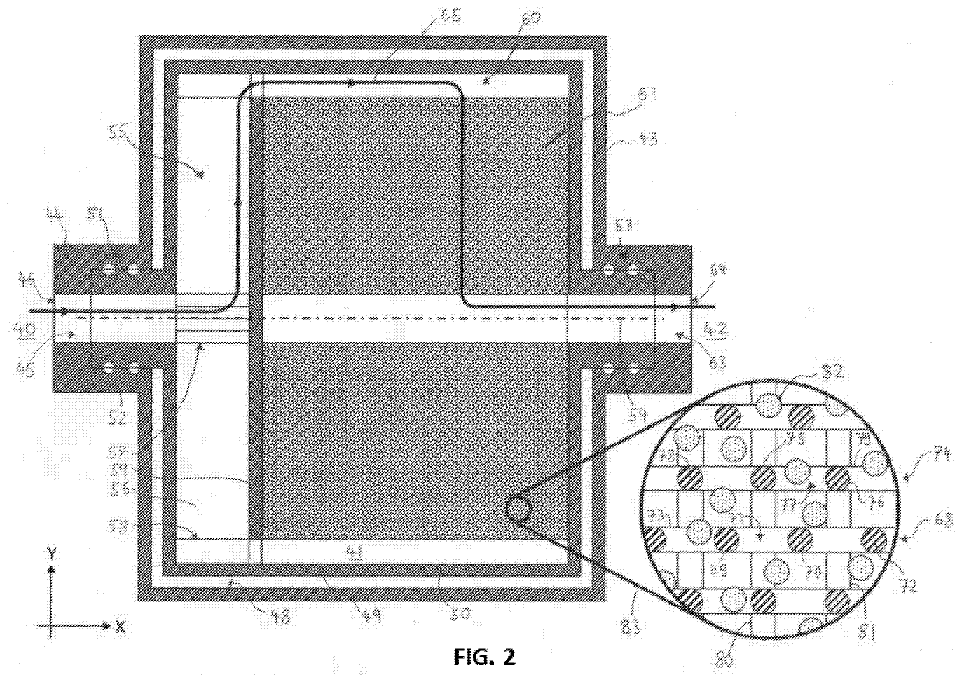

In other embodiments, a filtering apparatus can be configured in a different manner. A filtering apparatus can be configured in a manner in which the resistivity of the filtering apparatus to an OI moving from the first surface 4 through the filtering apparatus to the second surface 5, or vice versa, has a desired value. For instance, if a larger resistivity is desired, the filtering apparatus 16 can instead be configured similarly to filtering apparatus 61 shown in FIG. 2. The resistivity can be increased by reducing the length of the mean free path of an OI within the filtering apparatus, or by increasing the randomizing scattering effect experienced by an OI at each collision with the bulk material of the filtering apparatus, for example. By changing the effective geometry of a channel within a filtering apparatus, or by changing the surface roughness of the inside surface of a channel, the resistivity can be modified. For instance, a channel need not be straight as shown in FIG. 1, but can change direction within a distance less than or equal to the length of a mean free path of an OI within the filtering apparatus. For example, in FIG. 2, a channel can be considered to be S-shaped, where the height of the “S”, i.e. the extent of the “S” in the Y-direction, is on the order of a two mean free paths of an OI within filtering apparatus 61. In some embodiments, the surface roughness of the inside surface of a channel is artificially increased. This can be accomplished by treating the inside surface with chemicals, such as the chemicals used in industrial etching, during the manufacturing process, for example. In some embodiments, a filtering apparatus can also be described as a porous plug.

Axis 17, which is parallel to the X-axis, denotes the value of a given physical property at a given location along the Y-axis. Axis 18, which is parallel to the Y-axis, denotes the location along the Y-axis at which a given physical property is measured.

Line 19 denotes the value of the potential energy of an OI for the particular embodiment shown in FIG. 1. Dashed line 20 is a reference to the value of the potential energy in the remainder of the first reservoir 1 and the second reservoir 2. The volume of space within which the potential energy decreases in the positive Y-direction is denoted the “decreasing region”. The volume of space within which the potential energy increases in the positive Y-direction is denoted the “increasing region”. Note that the decreasing region lies within the first reservoir 1, and the increasing region lies in the filtering apparatus 16.

Line 23 denotes the approximate value of the density of OI. Dashed line 24 is a reference to the value of the density of an OI in the remainder of the first reservoir 1. Note that the embodiment in FIG. 1 is shown for a static boundary condition. In the simplified embodiment shown in FIG. 1, the density increases in the decreasing region of the potential well 19. In some embodiments, this increase can be modelled as a conventional, adiabatic compression of an ideal gas. As OI diffuse into the filtering apparatus 16, there is a slight increase in density. Within filtering apparatus 16, the density decreases to a lesser extent due to the wall friction experienced by OI at the inside surfaces of a channel of filtering apparatus 16. Dotted line 25 shows a theoretical scenario in which the density decrease is modelled in the absence of the effects of the filtering apparatus 16, i.e. in the same manner as the density increase in the decreasing region of the potential well. As OI diffuse from the filtering apparatus 16 into the second reservoir, there is a slight decrease in density. In the static boundary condition, the density in second reservoir 2 is larger than the density in first reservoir 1.

In other embodiments, the potential well 19 can take a different shape. For example, the potential energy of an OI can decrease at an increasing rate as opposed to a constant rate in the positive Y-direction in the decreasing region. The potential energy can also decrease at a decreasing rate for a portion of the decreasing region. The increasing region need not necessarily be configured in a similar fashion as the decreasing region. For instance, extent of the increasing region and decreasing region along the Y-axis need not be the same.

In accordance with some embodiments of the invention the resistivity experienced by an OI in the decreasing region of a potential well is smaller than the resistivity experienced by an OI in the increasing region of a potential well. In some embodiments, there is also a filtering apparatus in the decreasing region, where the resistivity is lower than the resistivity associated with an OI diffusing through the filtering apparatus in the increasing region. The resistivity of a filtering apparatus with respect to OI can be measured or calculated in the same sense in which the electrical resistivity of an electrical conductor with respect to electrons is established.

In the case in which the static boundary condition is replaced by a dynamic boundary condition, the average density in the first reservoir 1 and the second reservoir 2 is substantially constant. In this case, there is a net diffusion of OI from the first reservoir 1 and the second reservoir 2. As a result of the net diffusion of OI, there is a net force acting in the negative Y-direction on the filtering apparatus 16. Such a force can be employed to do mechanical work. This mechanical work can also be converted into electrical energy by means of an electric generator. In the case in which the OI carry charge, embodiments of the invention can be employed to produce electrical work. This electrical work can also be converted into mechanical work by means of an electric motor. Embodiments of the invention can therefore also be considered for applications involving power generation.

There are a wide variety of ways in which the aforementioned potential field can be produced. One can define a potential as the integral of the value of a force per unit mass over a displacement relative to a specified reference point. Note that a force acting on an object of interest or a fluid can be generated in a wide variety of ways. Note that, for the purposes of the present invention, a force need not be generated by a field, but can also be generated by a mechanical apparatus, such as an axial or centrifugal compressor or expander, or a converging diverging duct or nozzle, or a Tesla turbine. A conventional compressor or expander of a fluid can therefore also be considered to be a body force generating apparatus. The potential field associated with this body force generating apparatus can be considered to be an effective potential field, which is analogous to other physical fields, such as gravitational, magnetic, or electric fields. In general, the term “potential field” as used herein also refers to effective potential fields, and the term “effective potential field” also refers to potential fields such as gravitational fields.

One can define the position within any reservoir which is subject to a body force per unit mass in terms of the value of a potential at that position. For a given potential, there is a set of possible points within the reservoir at which the value of the potential is the value of the given potential. In general, this set describes a three dimensional equipotential surface. For example, consider a simplified case in which a medium inside a reservoir is subject to a body force per unit mass, where the body force is uniform in magnitude and direction throughout the reservoir and constant in time. The reservoir is an isolated system, i.e. closed and perfectly insulated, and has the shape of a cylinder with length L and radius R, for instance. One can define a Cartesian reference frame, with the z-axis parallel to the length L of the cylinder, and parallel to, and directed in the opposite direction of, the body force per unit mass. The origin of the reference frame is the center of the circular area at the top of the cylinder, where the “top” is defined relative to the z-axis. In this case, the equipotential surfaces are planes perpendicular to the z-axis. A reference point can be defined to be the origin of the reference frame. The value of the potential at the top of the cylinder is therefore zero, while the value of the potential at the bottom of the cylinder is equal to the negative value of the product of the body force per unit mass and the length L of the cylinder. The equipotential surfaces for other embodiments can be found using similar principles. In the embodiment shown in FIG. 1, the potential field is assumed to be uniform in the XZ-plane, i.e. an equipotential surface is parallel to the XZ-plane.

Note that the potential in this context is a mathematical construct, and need not have a physical manifestation. In other words, the potential need not be produced by a physical force field, but can be produced “manually”, i.e. by a separate mechanical mechanism, such as an axial compressor used in turbomachinery. Note that there is no net flow of OI in the static boundary condition.

In FIG. 1 there is a body force per unit mass acting on at least the OI in the decreasing region and the increasing region. Outside of these regions, the body force per unit mass is zero. In this simplified example, the body force is constant in time, as well as constant in magnitude and direction within the decreasing region and within the increasing region. In the decreasing region, the body force is directed in the positive Y-direction, and parallel to the Y-axis. In the increasing region, the body force is directed in the negative Y-direction, and parallel to the Y-axis. In other embodiments, the body force need not be distributed uniformly in space, or be constant in time within the decreasing region or within the increasing region.

There are numerous ways in which such body forces per unit mass can be generated.

One type of such a body force per unit mass is the gravitational acceleration acting on a medium. In such instances it can be impractical to change the direction of the body force in the decreasing region and the increasing region. Instead, the path followed by OI diffusing from the first reservoir 1 to the second reservoir 2 can be turned through 180 degrees at the locally lowest point of the potential well, as illustrated in FIG. 2. In other embodiments the particle path can be turned through less than 180 degrees. This can be desirable if there is a large axial flow velocity component, i.e. a large velocity component in a direction perpendicular to the body force direction.

A body force can arise from the existence of a physical or conventional potential field gradient. One such example is the force which arises from the gradient of an electric potential. For example, the elements of a medium can be configured to be electrically charged. In the context of a medium, the term “elements” refers to the constituent parts of the medium, such as sub-molecular particles, molecules, or a distinct or specified collection of molecules, for example. In the case of a gas, the molecules could be positively or negatively ionized, for instance. The medium can also comprise a collection of mobile electrons or holes. Note that this collection can be contained in a solid, such as electrons contained in a metal conductor, or it can be described as a gas. By applying an electric field in a reservoir or a filtering apparatus, body forces per unit mass can be generated on the electrically charged elements of the medium inside the reservoir or filtering apparatus. For example, in the case in which the OI are negatively charged, an electric field can be generated by embedding positive charges within an insulating material at, or in proximity of, first surface 4. These positive charges generate an attractive body force per unit mass on the negatively charged, mobile OI. This body force is directed in the positive Y-direction in first reservoir in the region located in the negative Y-direction of first surface 4, i.e. the decreasing region, as intended. This body force is also directed in the negative Y-direction in the filtering apparatus 16, i.e. in the region located in the positive Y-direction of first surface 4, i.e. the increasing region, as intended.

For other embodiments it can be impossible or inconvenient to use, procure, or create a medium with mobile electrical charges. In this case, elements of the medium can be polarized by applying an electric field, such as air molecules, or these elements can already have an intrinsic polarization, as in the case of polar molecules, such as water molecules. When placed in an electric field gradient, these polarized elements can experience a body force. Note that the magnitude of said force depends on the orientation of the polarization axis relative to the electric field, amongst other parameters. Thus an electric field can be configured to generate body forces per unit mass on the polar elements in the medium in a reservoir, as well as polarize elements in the medium, if necessary. A suitable electric field can be applied in a myriad of ways, such as the aforementioned embedding of static electric charges within an insulating material, where the location and the magnitude of the charges are configured to produce the desired electric field gradient. For example, alternating positive and negative insulated, static charge collections can be placed at, or in proximity of first surface 4. Alternatively, or concurrently, the charge density can increase in the positive Y-direction in the decreasing region, and decrease in the positive Y-direction in the increasing region.

Magnetism can also be employed to generate body forces. The medium can comprise diamagnetic, paramagnetic, or ferromagnetic elements. When magnetized, the individual elements in the medium can form magnetic dipoles, or these elements can already have an intrinsic magnetic dipole, such as an electron. When these magnetic dipoles are placed in a magnetic field with a non-zero curl or gradient, they can experience a body force. Note that the magnitude of the body force is a function of the orientation of the magnetic dipole relative to the local magnetic field, amongst other parameters. Thus an external magnetic field can be configured to generate body forces per unit mass on the magnetized elements in the medium in a reservoir, as well as magnetize the elements in the medium, if necessary. The magnetic field can be generated by ferromagnets other at least instantaneously magnetized elements, or by an electrical current flowing through an electromagnet, amongst other methods known in the art.

The body forces per unit mass can also arise from inertial effects. For instance, a reservoir or a filtering apparatus can be subject to an acceleration in an inertial frame. This results in an acceleration of the elements of the medium, such as OI, relative to the reservoir or the filtering apparatus, which has the same effect as a body force per unit mass acting on the elements of the medium relative to the reservoir or the filtering apparatus. Inertial forces can be generated by linear acceleration, i.e. motion of the reservoir or filtering apparatus along a straight line in the inertial frame. Inertial forces can also be generated by angular acceleration, i.e. motion of the reservoir or filtering apparatus along a curved path. In general, inertial forces can be generated by any accelerating motion in an inertial frame. The case in which a portion of a reservoir or filtering apparatus undergoes circular motion in an inertial frame during nominal operations is discussed in the context of FIG. 2. Note that the centripetal acceleration varies linearly with radius in this embodiment. If a substantially uniform body force per unit mass of medium is desired, the depicted apparatus can be located at a larger radius, where the radial dimension of the apparatus is only a fraction of said radius.

Embodiments employing other types of body forces per unit mass, or combinations thereof, are within the spirit and scope of the invention.

FIG. 2 shows a cross-sectional view of another embodiment of the invention. Some features of the apparatus shown in FIG. 2, as well as some of the principles of operation of the apparatus share similarities with the apparatus shown in FIG. 1, and will therefore not be described in the same detail in the context of FIG. 2, and vice versa.

The embodiments shown in FIG. 2 are axially symmetric unless specified or clear from context, where the axis of symmetry is parallel to and coincident with axis 54.

There is a first station 40, a second station 41, and a third station 42. For a static boundary condition, first station 40 can be considered to lie in a first reservoir, and third station 42 can be considered to lie in a second reservoir.

There is an outside casing 43 made of bulk material 44 and an inside casing 49 made of bulk material 50. Bulk materials 44 and 50 can be made of any suitable material, just like bulk material 3. For example, bulk materials 44 or 50 can comprise metals, or composite materials such as fiberglass or carbon fiber. Inside casing 49 is configured to rotate relative to outside casing 43 about axis 54, which is parallel to the X-axis. In the embodiment shown, a vacuum 48 separates a portion of inside casing 49 from outside casing 43. This reduces the viscous friction drag associated with the rotation of inside casing 49 within outside casing 43. In some embodiments, there can be a fluid such as a liquid or a gas located within the space between inside casing 49 and outside casing 43. The properties of the fluid can be selected to minimize or reduce the viscous drag between inside casing and the fluid, amongst other selection criteria.

Outside casing 43 and inside casing 49 are substantially cylindrical in shape, with the symmetry axes of the cylinders being parallel to and coincident with axis 54.

A first rotation support apparatus 51 and a second rotation support apparatus 53 facilitate the relative rotation between inside casing 49 and outside casing 43, while also allowing the transfer of mechanical loads between inside casing 49 and outside casing 43. A rotation support apparatus can comprise a bearing assembly, such as bearing assembly 52. A rotation support can also comprise an electric motor in order to actuate and control the relative rotation speed between inside casing 49 and outside casing 43. In the embodiment shown, outside casing is not rotating within an inertial frame. The rotation support also seals the vacuum 48 from the interior of inside casing 49.

There is a first channel 45 with a first channel opening 46, and a second channel 63 with a second channel opening 64. These channels are cylindrical in shape in this embodiment.

In some embodiments, first channel 45 or second channel 63 is connected to another thermodynamic device, such as a compressor, a turbine, a duct, or a nozzle. The compressor or turbine can be an axial or centrifugal compressor or turbine, as used in turbomachinery. The compressor or turbine can alternatively, or concurrently, comprise a reciprocating piston in some embodiments. For example, an axial flow compressor can be used to decelerate and compress ambient air before it enters first channel 45, and an axial flow turbine can be used to accelerate and expand the flow after it exits second channel 63. During this expansion process, more mechanical work can be done by the fluid than is done on the fluid by the compressor, for some embodiments or applications. In some embodiments, the compression upstream of first channel 45 can be carried out by a duct or an artificial constriction in the flow, i.e. a decrease and/or increase in the cross-sectional area of the flow, depending on the flow speed. In some embodiments, the downstream expansion can be carried out in a conventional nozzle. In some embodiments, the flow is expanded upstream of first channel 45 and compressed downstream of second channel 63. As before, during the expansion process, more mechanical work can be done by the fluid on the expansion apparatus compared to the work done on the fluid by the compressing apparatus, for some embodiments or applications.

For the static boundary condition, there is no net flow of OI between stations 42 and 40, but a higher OI density at station 42 compared to station 40, similarly to the embodiment shown in FIG. 1. For the dynamic boundary condition, there can be a net flow of OI from station 40 to station 42, as indicated by approximate, average particle path 65. Note that for other boundary conditions the flow direction of OI is from station 42 to station 40.

A compression segment 55 comprises several baffles, such as baffle 56 with a top edge 57 and a bottom edge 58. In this particular embodiment, a baffle can be described as a thin, two dimensional plate with an outward normal perpendicular to axis of rotation 54 and a vector directed in the radially outward direction. Compression segment 55 can therefore also be considered to be a conventional centrifugal compressor, where a baffle, such as baffle 56, is a compressor blade. A wide variety of alternative configurations of compression segment 55 are therefore available. Compression segment 55 can be considered to be analogous to decreasing region described in the context of FIG. 1. The body force per unit mass acting on an OI in this decreasing region is the inertial acceleration acting on an OI due to the rapid rotation of inside casing 49 and the associated bulk material of compression segment 55 in the inertial frame. This inertial acceleration is directed in a radially outward direction. Therefore, the potential energy of an OI can be considered to be lower at station 41 than it is at station 40 for the static boundary condition. Correspondingly, the temperature and density are larger at station 41 compared to station 40, as indicated in FIG. 1. In this particular embodiment, these temperature and density increases within compression segment 55 can be modelled as an adiabatic compression of an ideal gas.

A filtering apparatus 61 is configured to allow OI to diffuse from station 41 through filtering apparatus 61 into second channel 63 and to station 42, and vice versa, for the static boundary condition. Filtering apparatus 61 can be described as a porous plug, or a fabric, or an aerogel, or a foam in some embodiments. The resistivity of OI diffusing or moving through filtering apparatus 61 is larger than the resistivity of OI diffusing or moving through compression segment 65. The average wall shear stress coefficient, or the friction coefficient, associated with compression region 55 is lower than the same for filtering apparatus 61 in accordance with some embodiments of the invention. Filtering apparatus 61 performs a similar function as filtering apparatus 16 in FIG. 1. Filtering apparatus 61 can be considered to lie within an expansion region of OI, i.e. the increasing region described in the context of FIG. 1. The volume within filtering apparatus 61 which is accessible to objects of interest can also be described as a channel system.

Enlargement 83 shows details of an example embodiment of filtering apparatus 61. Filtering apparatus comprises several layers, such as layers 74 and 68. Each layer comprises several cylindrical tubes, such as tube 75, 76, 70, or 69. Each cylindrical tube is made of bulk material, such as bulk material 72 or bulk material 78.

In FIG. 1, the bulk material of the filtering apparatus 61, such as bulk material 72 or bulk material 78, is identical. The aforementioned circular tubes, such as tube 70, can consist of a polymer, i.e. a single chain of monomer molecules. In other embodiments, the circular tubes can represent a chain of single molecules, such that the diameter of a circular tube is equal to the diameter of a single molecule. In other embodiments, the circular tubes can be carbon nanotubes. The bulk material of the filtering apparatus 61 need not form a structured lattice. In some embodiments, the bulk material of the filtering apparatus 61 can comprise tubes which are arranged in random fashion. The bulk material of the filtering apparatus 61 can thus be described as a forest or a random or arbitrary arrangement or mixture of tubes, as opposed to a lattice of tubes depicted in FIG. 2. In other embodiments the bulk material of the filtering apparatus 61 can also form a three-dimensional lattice of atoms or molecules, where the spacing between elements of the lattice is large enough for OI, such as OI 82, to diffuse through the lattice. In some embodiments filtering apparatus 61 can be described as a fabric or a textile.

The space between circular tubes, such as tubes 70 and 69, forms a channel, such as channel 71 or channel 77. Axial support structures, such as support structures 73 and 79, as well as radial support structures, such as support structures 80 and 81, rigidly connect layers to each other and provide structural support.

### ASPECTS OF THE INVENTION

The invention is further defined by the following aspects.

Aspect 1. A filtering apparatus, wherein the filtering apparatus comprises: a force generating apparatus; a first channel system, wherein the first channel system comprises a first point and a second point, wherein objects of interest are able to move through the first channel system between the first point and second point, wherein the force generating apparatus can be configured to apply a force on objects of interest within at least a portion of the channel system, wherein the force comprises a non-zero component directed from the first point towards the second point on average; and a second channel system, wherein the second channel system comprises a first point and a second point, and wherein objects of interest are able to move through the second channel system between the first point and second point, wherein the force generating apparatus can be configured to apply a force on objects of interest within at least a portion of the channel system, wherein the force comprises a non-zero component directed from the first point towards the second point on average; and wherein the second point in the second channel system is diffusively coupled to the second point in the first channel system, and wherein the average shear stress coefficient of the second channel system between the first point and the second point is larger than the average shear stress coefficient of the first channel system between the first point and the second point

Aspect 2. The apparatus of aspect 1, wherein the first point in the first channel system is diffusively coupled to a first reservoir

Aspect 3. The apparatus of aspect 1, wherein the first point in the second channel system is diffusively coupled to a second reservoir

Aspect 4. The apparatus of aspect 1, wherein an diffusive coupling comprises a channel through which objects of interest can move

Aspect 5. The apparatus of aspect 1, wherein at least a portion of the first channel system is isolated from a second channel system

Aspect 6. The apparatus of aspect 1, wherein the force generating apparatus comprises an electric field generating apparatus, wherein at least a portion of the force is electric in nature

Aspect 7. The apparatus of aspect 1, wherein the force generating apparatus comprises a gravitational field generating apparatus, and wherein at least a portion of the force is gravitational in nature

Aspect 8. The apparatus of aspect 1, wherein the force generating apparatus comprises a magnetic field generating apparatus, and wherein at least a portion of the force is magnetic in nature

Aspect 9. The apparatus of aspect 1, wherein the force generating apparatus comprises an electromagnetic field generating apparatus, and wherein at least a portion of the force is electromagnetic in nature

Aspect 10. The apparatus of aspect 1, wherein the force generating apparatus comprises an accelerating apparatus, wherein the accelerating apparatus is configured to accelerate the first channel system or the second channel system in an inertial frame, and wherein at least a portion of the force is inertial in nature

Aspect 11. The apparatus of aspect 10, wherein the accelerating apparatus is configured to rotate the first channel system or the second channel system, thereby accelerating the interior surfaces of the channel system relative to the objects of interest

Aspect 12. The apparatus of aspect 1, wherein the force generating apparatus comprises a work exchange apparatus configured to do work on the objects of interest, or allowing the objects of interest to do work on the work exchange apparatus

Aspect 13. The apparatus of aspect 12 wherein the work exchange apparatus comprises a centrifugal compressor, or a centrifugal turbine

Aspect 14. The apparatus of aspect 12, wherein the work exchange apparatus comprises a axial compressor, or a axial turbine

Aspect 15. The apparatus of aspect 12, wherein the work exchange apparatus comprises a converging duct, a diverging duct, or a converging diverging duct

Aspect 16. The apparatus of aspect 1, wherein the objects of interest in the first channel system or second channel system comprise air molecules

Aspect 17. The apparatus of aspect 1, wherein the objects of interest in the first channel system or second channel system comprise molecules in a gas

Aspect 18. The apparatus of aspect 1, wherein the objects of interest in the first channel system or second channel system comprise molecules in a liquid

Aspect 19. The apparatus of aspect 1, wherein the objects of interest in the first channel system or second channel system comprise waves, or wavelike particles

Aspect 20. The apparatus of aspect 19, wherein the objects of interest in the first channel system or second channel system comprise phonons

Aspect 21. The apparatus of aspect 1, wherein the bulk material of a first channel system or second channel system comprises a metal

Aspect 22. The apparatus of aspect 1, wherein the bulk material of a first channel system or second channel system comprises composite materials

Aspect 23. The apparatus of aspect 1, wherein the bulk material of a first channel system or second channel system comprises carbon nanotubes

Aspect 24. The apparatus of aspect 1, wherein the average mean free path between the first and second points in the second material is smaller than the average mean free path between the first and second points in the first material

Aspect 25. The apparatus of aspect 1, wherein the average resistivity to bulk flow of objects of interest between the first and second points in the second material is larger than the average resistivity to bulk flow of objects of interest between the first and second points in the first material

Aspect 26. The apparatus of aspect 1, wherein the characteristic width of a channel within a channel system in the second material is smaller than 1000 times the mean free path of objects of interest within the fluid comprising the objects of interest for at least a portion of the second material

Aspect 27. The apparatus of aspect 2, wherein a second reservoir is diffusively coupled to the first point in the second channel system

Aspect 28. The apparatus of aspect 27, wherein the pressure in the second reservoir can be larger than the pressure in the first reservoir for a static boundary condition, wherein the difference in pressure is at least in part due to the interaction of the objects of interest with the filtering apparatus

Aspect 29. The apparatus of aspect 1, wherein a bulk flow of objects of interest can be generated throughout the first or second channel system

Aspect 30. The apparatus of aspect 29, wherein a compressor or expander is located upstream of the first channel system and configured to interact with objects of interest

Aspect 31. The apparatus of aspect 29, wherein a compressor or expander is located downstream of the first channel system and configured to interact with objects of interest

Aspect 32. The apparatus of aspect 31, wherein a compressor or expander is located downstream of the second channel system and configured to interact with objects of interest

Aspect 33. The apparatus of aspect 29, wherein a heat exchanger is located downstream of the first channel system and configured to interact with objects of interest

Aspect 34. The apparatus of aspect 33, wherein a heat exchanger is located downstream of the second channel system and configured to interact with objects of interest

Aspect 35. The apparatus of aspect 1, wherein the first point in the first channel system is diffusively coupled with a first point in the second channel system

Aspect 36. The apparatus of aspect 35, wherein the apparatus can be configured to comprise a closed thermodynamic system, wherein objects of interest can flow from the first point in the first channel system to the second point in the first channel system, and via the first diffusive coupling from the second point in the first channel system to the second point in the second channel system, and from the second point in the second channel system to the first point in the second channel system, and via the second diffusive coupling from the first point in the second channel system to the first point in the first channel system.

Aspect 37. The apparatus of aspect 36, wherein the first or second diffusive coupling comprises a compressor, an expander, or a heat exchanger configured to interact with objects of interest

Aspect 38. A system comprising two or more of the filtering apparatuses of aspect 1

Aspect 39. The system of aspect 38, wherein a first filtering apparatus is diffusively coupled in series with a second filtering apparatus

Aspect 40. The system of aspect 35, wherein a first filtering apparatus is diffusively coupled in parallel with a second filtering apparatus

Aspect 41. A method of filtering, comprising: providing a filtering apparatus of aspect 1

Aspect 42. A method of filtering, comprising: providing a force generating apparatus; providing a first channel system, wherein the first channel system comprises a first point and a second point, wherein objects of interest are able to move through the first channel system between the first point and second point; employing the force generating apparatus to apply a force on objects of interest within at least a portion of the first channel system, wherein the force comprises a non-zero component directed from the first point towards the second point on average; a second channel system, wherein the second channel system comprises a first point and a second point, and wherein objects of interest are able to move through the second channel system between the first point and second point; employing the force generating apparatus to apply a force on objects of interest within at least a portion of the second channel system, wherein the force comprises a non-zero component directed from the first point towards the second point on average; diffusively coupling the second point in the second channel system to the second point in the first channel system, and configuring the geometry of the first channel system relative to the second channel system such that the average shear stress coefficient of the second channel system between the first point and the second point is larger than the average shear stress coefficient of the first channel system between the first point and the second point

Aspect 43. The method of aspect 42, wherein the method further comprises providing a work exchange apparatus to compress or expand the working material upstream or downstream of the filtering apparatus

Aspect 44. The method of aspect 42, wherein the method further comprises providing a heat exchange apparatus to deliver heat to the working material, or extract heat from the working material, upstream or downstream of the filtering apparatus

Aspect 45. The method of aspect 42, wherein the method further comprises diffusively coupling the first point in the second channel system to the first point in the first channel system, thereby forming a closed thermodynamic system.

Unless specified or clear from context, the term “or” is equivalent to “and/or” throughout this paper.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiments is described or depicted. Those skilled in the art will be able to devise numerous alternative examples, embodiments, arrangements, configurations, or methods of operation, that, while not shown or described herein, embody the principles of the invention and thus are within its spirit and scope.

What is claimed is:

1. A filtering apparatus, wherein the filtering apparatus comprises:
a force generating apparatus;
a first channel system, wherein the first channel system comprises a first point and a second point, wherein objects of interest are able to move through the first channel system between the first point and second point, wherein the force generating apparatus can be configured to apply a force on objects of interest within at least a portion of the channel system, wherein the force comprises a non-zero component directed from the first point towards the second point on average; and
a second channel system, wherein the second channel system comprises a first point and a second point, and wherein objects of interest are able to move through the second channel system between the first point and second point, wherein the force generating apparatus can be configured to apply a force on objects of interest within at least a portion of the channel system, wherein the force comprises a non-zero component directed from the first point towards the second point on average; and
wherein the second point in the second channel system is diffusively coupled to the second point in the first channel system, and
wherein the average shear stress coefficient of the second channel system between the first point and the second point is larger than the average shear stress coefficient of the first channel system between the first point and the second point

2. The apparatus of claim 1, wherein the first point in the first channel system is diffusively coupled to a first reservoir

3. The apparatus of claim 1, wherein the first point in the second channel system is diffusively coupled to a second reservoir

4. The apparatus of claim 1, wherein an diffusive coupling comprises a channel through which objects of interest can move

5. The apparatus of claim 1, wherein at least a portion of the first channel system is isolated from a second channel system

6. The apparatus of claim 1, wherein the force generating apparatus comprises an electric field generating apparatus, wherein at least a portion of the force is electric in nature

7. The apparatus of claim 1, wherein the force generating apparatus comprises a gravitational field generating apparatus, and wherein at least a portion of the force is gravitational in nature

8. The apparatus of claim 1, wherein the force generating apparatus comprises a magnetic field generating apparatus, and wherein at least a portion of the force is magnetic in nature

9. The apparatus of claim 1, wherein the force generating apparatus comprises an electromagnetic field generating apparatus, and wherein at least a portion of the force is electromagnetic in nature

10. The apparatus of claim 1, wherein the force generating apparatus comprises an accelerating apparatus, wherein the accelerating apparatus is configured to accelerate the first channel system or the second channel system in an inertial frame, and wherein at least a portion of the force is inertial in nature

11. The apparatus of claim 10, wherein the accelerating apparatus is configured to rotate the first channel system or the second channel system, thereby accelerating the interior surfaces of the channel system relative to the objects of interest

12. The apparatus of claim 1, wherein the force generating apparatus comprises a work exchange apparatus configured to do work on the objects of interest, or allowing the objects of interest to do work on the work exchange apparatus

13. The apparatus of claim 12 wherein the work exchange apparatus comprises a centrifugal compressor, or a centrifugal turbine

14. The apparatus of claim 12, wherein the work exchange apparatus comprises a axial compressor, or a axial turbine

15. The apparatus of claim 12, wherein the work exchange apparatus comprises a converging duct, a diverging duct, or a converging diverging duct

16. The apparatus of claim 1, wherein the objects of interest in the first channel system or second channel system comprise air molecules

17. The apparatus of claim 1, wherein the objects of interest in the first channel system or second channel system comprise molecules in a gas

18. The apparatus of claim 1, wherein the objects of interest in the first channel system or second channel system comprise molecules in a liquid

19. The apparatus of claim 1, wherein the objects of interest in the first channel system or second channel system comprise waves, or wavelike particles

20. The apparatus of claim 19, wherein the objects of interest in the first channel system or second channel system comprise phonons

21. The apparatus of claim 1, wherein the bulk material of a first channel system or second channel system comprises a metal

22. The apparatus of claim 1, wherein the bulk material of a first channel system or second channel system comprises composite materials

23. The apparatus of claim 1, wherein the bulk material of a first channel system or second channel system comprises carbon nanotubes

24. The apparatus of claim 1, wherein the average mean free path between the first and second points in the second material is smaller than the average mean free path between the first and second points in the first material

25. The apparatus of claim 1, wherein the average resistivity to bulk flow of objects of interest between the first and second points in the second material is larger than the average resistivity to bulk flow of objects of interest between the first and second points in the first material

26. The apparatus of claim 1, wherein the characteristic width of a channel within a channel system in the second material is smaller than 1000 times the mean free path of objects of interest within the fluid comprising the objects of interest for at least a portion of the second material

27. The apparatus of claim 2, wherein a second reservoir is diffusively coupled to the first point in the second channel system

28. The apparatus of claim 27, wherein the pressure in the second reservoir can be larger than the pressure in the first reservoir for a static boundary condition, wherein the difference in pressure is at least in part due to the interaction of the objects of interest with the filtering apparatus

29. The apparatus of claim 1, wherein a bulk flow of objects of interest can be generated throughout the first or second channel system

30. The apparatus of claim 29, wherein a compressor or expander is located upstream of the first channel system and configured to interact with objects of interest

31. The apparatus of claim 29, wherein a compressor or expander is located downstream of the first channel system and configured to interact with objects of interest

32. The apparatus of claim 31, wherein a compressor or expander is located downstream of the second channel system and configured to interact with objects of interest

33. The apparatus of claim 29, wherein a heat exchanger is located downstream of the first channel system and configured to interact with objects of interest

34. The apparatus of claim 33, wherein a heat exchanger is located downstream of the second channel system and configured to interact with objects of interest

35. The apparatus of claim 1, wherein the first point in the first channel system is diffusively coupled with a first point in the second channel system

36. The apparatus of claim 35, wherein the apparatus can be configured to comprise a closed thermodynamic system, wherein objects of interest can flow from the first point in the first channel system to the second point in the first channel system, and via the first diffusive coupling from the second point in the first channel system to the second point in the second channel system, and from the second point in the second channel system to the first point in the second channel system, and via the second diffusive coupling from the first point in the second channel system to the first point in the first channel system.

37. The apparatus of claim 36, wherein the first or second diffusive coupling comprises a compressor, an expander, or a heat exchanger configured to interact with objects of interest

38. A system comprising two or more of the filtering apparatuses of claim 1

39. The system of claim 38, wherein a first filtering apparatus is diffusively coupled in series with a second filtering apparatus

40. The system of claim 35, wherein a first filtering apparatus is diffusively coupled in parallel with a second filtering apparatus

41. A method of filtering, comprising: providing a filtering apparatus of claim 1

42. A method of filtering, comprising:
providing a force generating apparatus;
providing a first channel system, wherein the first channel system comprises a first point and a second point, wherein objects of interest are able to move through the first channel system between the first point and second point;
employing the force generating apparatus to apply a force on objects of interest within at least a portion of the first channel system, wherein the force comprises a non-zero component directed from the first point towards the second point on average;
a second channel system, wherein the second channel system comprises a first point and a second point, and wherein objects of interest are able to move through the second channel system between the first point and second point;
employing the force generating apparatus to apply a force on objects of interest within at least a portion of the second channel system, wherein the force comprises a non-zero component directed from the first point towards the second point on average;
diffusively coupling the second point in the second channel system to the second point in the first channel system, and
configuring the geometry of the first channel system relative to the second channel system such that the average shear stress coefficient of the second channel system between the first point and the second point is larger than the average shear stress coefficient of the first channel system between the first point and the second point

43. The method of claim 42, wherein the method further comprises providing a work exchange apparatus to compress or expand the working material upstream or downstream of the filtering apparatus

44. The method of claim 42, wherein the method further comprises providing a heat exchange apparatus to deliver heat to the working material, or extract heat from the working material, upstream or downstream of the filtering apparatus

45. The method of claim 42, wherein the method further comprises diffusively coupling the first point in the second channel system to the first point in the first channel system, thereby forming a closed thermodynamic system
